(19) United States
(12) Patent Application Publication
(10) Pub. No.: US 2008/0025138 A1
(43) Pub. Date: Jan. 31, 2008

(54) MORTOR MIXING STAND

(76) Inventor: Jason E. Cherry, White Settlement, TX (US)

Correspondence Address: GUY V. MANNING, 1407 TEXAS STREET, SUITE 102, FORT WORTH, TX, 76102, US

(21) Appl. No.: 11/460,919

(22) Filed: Jul. 28, 2006

(51) Int. Cl. B28C 5/00

(52) U.S. Cl. 366/2

(57) ABSTRACT

A stand holds a bag of dry mortar mix while a user pours measured quantities therefrom to prepare a mortar admix in a mixing container. The stand has a base with folding legs which elevates the bag to approximately the level of the top of the mixing container. A platform, or elevator, hingedly coupled to the front of the base holds the dry mortar bag while a user tilts the elevator and bag for pouring. A chute on the platform channels the dry mortar into the container as needed while the user stirs it with water to prepare the mortar admix. The elevator includes a handle opposite the hinge for manipulating the bag. A vertical spine atop the elevator near the handle slips under a flap on the end of the bag to hold it erect and in place while pouring. The device includes one or more latches which hold the elevator and legs in their folded positions adjacent the base for transportation and storage.

### BACKGROUND OF THE INVENTION

1. Field of the Invention

This invention relates generally to construction tools and procedures, and particularly to mortar mixing activities. More particularly, this invention relates to stand for holding a bag of dry mortar mix while an admix of dry mortar and water is prepared for use in a tile setting or other mortaring project.

2. Description of Related Art

Mortar and other admixes such as concrete used in construction projects often are supplied in small quantities of dry powder contained in sacks. Having a generally rectangular shape approximately two feet high, four to six inches thick and twelve to eighteen inches wide, the sacks typically are sized to be handled manually. The weight of a filled sack varies with the material inside, a mortar mix bag typically weighing approximately fifty to eighty pounds. The sacks usually are made of paper and have access flaps on both ends for opening and pouring the dry mortar to mix it with water for use. Often the entire bag is not needed all at once, and only portions are poured into water and the admix is stirred to assure its proper proportions.

An eighty pound bag of dry mortar mix can be cumbersome to handle, especially while pouring measured amounts of mortar into a mixing container. A user doing so is faced either with trying to hold the bag with one arm while pouring the mortar, adding water and stirring with the other arm, or with repeatedly lifting the bag to pour measured amounts of dry mortar and then setting it aside while mixing it with the water. A third alternative is to have a second person assist. All three alternatives generate significant cost penalties from labor time consumed, risks of injury and wastage of mortar spilled during handling. Means for manipulating a mortar mix bag that enables a user conveniently to mix mortar without assistance or risk of injury or waste would create significant efficiencies.

### SUMMARY OF THE INVENTION

Accordingly, it is an object of this invention to provide means for holding a container of dry mortar while pouring measured amounts therefrom for use.

It is another object of this invention to provide means for increasing efficiencies in the mortar mixing process.

It is another object of this invention to provide means to minimize risk of injury and wastage while mixing mortar for a project.

It is yet another object of this invention to provide means for minimizing costs in the mortar mixing process.

The foregoing and other objects of this invention are achieved by providing a stand for holding a bag of dry mortar mix while pouring measured quantities therefrom to prepare a mortar admix in a mixing container. The stand has a base with folding legs which elevates the bag to approximately the level of the top of the mixing container. A platform, or elevator, hingedly coupled to the front of the base holds the dry mortar bag while a user tilts the elevator and bag for pouring. A chute on the platform channels the dry mortar into the container as needed while the user stirs it with water to prepare the mortar admix. The elevator includes a handle opposite the hinge for manipulating the bag. A vertical spine atop the elevator near the handle slips under a flap on the end of the bag to hold it erect and in place while pouring. The device includes one or more latches which hold the elevator and legs in their folded positions adjacent the base for transportation and storage.

### BRIEF DESCRIPTION OF THE DRAWINGS

The novel features believed characteristic of the present invention are set forth in appended claims. The invention itself, however, as well as a preferred mode of use and further objects and advantages thereof, will best be understood by reference to the following detailed description of an illustrative embodiment when read in conjunction with the accompanying drawings, wherein:

FIG. 1 depicts a side elevational view of the present invention in use.

FIG. 2 details a rear end elevational view of the invention as indicated in FIG. 1.

FIG. 3 details in partial plan view as indicated in FIG. 1 the top of the base of the invention in use.

FIG. 4 shows a left side elevational view of the invention of FIG. 1 folded for transportation and storage.

FIG. 5 shows a bottom elevational view as indicated in FIG. 4 the present invention folded as in FIG. 4 .

### DETAILED DESCRIPTION OF A PREFERRED EMBODIMENT

With reference now to the figures, and particularly FIGS. 1-3, stand 10 comprises base 11 elevated above resting surface, or ground, 2 by front legs 30 and rear leg assembly 40. Hingedly coupled to the front of base 11, platform, or elevator, 20 holds dry mortar bag 5 resting on one of its long sides and tilts bag 5 to pour therefrom dry mortar 3. Coupled to the front of base 11, curvilinear shoe 17 faces forward from base 11 to embrace mixing container 7 in which mortar admix 4 is prepared for use. A user (not shown) raises elevator 20 to initiate and regulate the amount of mortar 3 channeled into container 7 while stirring it with water (not shown) to mix therewith to create admix 4.

Base 11 comprises an elongate, rectangular platform having a length approximating the height (long side) of bag 5 and bifurcated by longitudinal axis B. Base 11 preferably is fabricated from a weldment of schedule 80 aluminum channel having base back 12 sandwiched between base sides 14, the latter giving base 11 rigidity and a location on which to attach front legs 30. Preferably, sides 14 are disposed along back 12 such that they extend upward therefrom (away from resting surface 2) and flush with planar back 12 beneath base 11.

Base 11 further includes latch means 50 and apertures 13 which are both preferably disposed on back 12 along axis B and which are discussed in more detail below. As discussed above, shoe 17 couples to the front of base 11 symmetrically transverse axis B and comprises an interface having a partially curved shape substantially matching the outer curvature of mixing container 7. One having ordinary skill in the art will recognize that shoe 17 may comprise any number of configurations designed to secure a reliable interface means between base 11 and container 7, such as clamps, recesses for a portion of container 7 or the like (none shown), and that all such potential configurations are considered to be within the spirit and scope of the present invention.

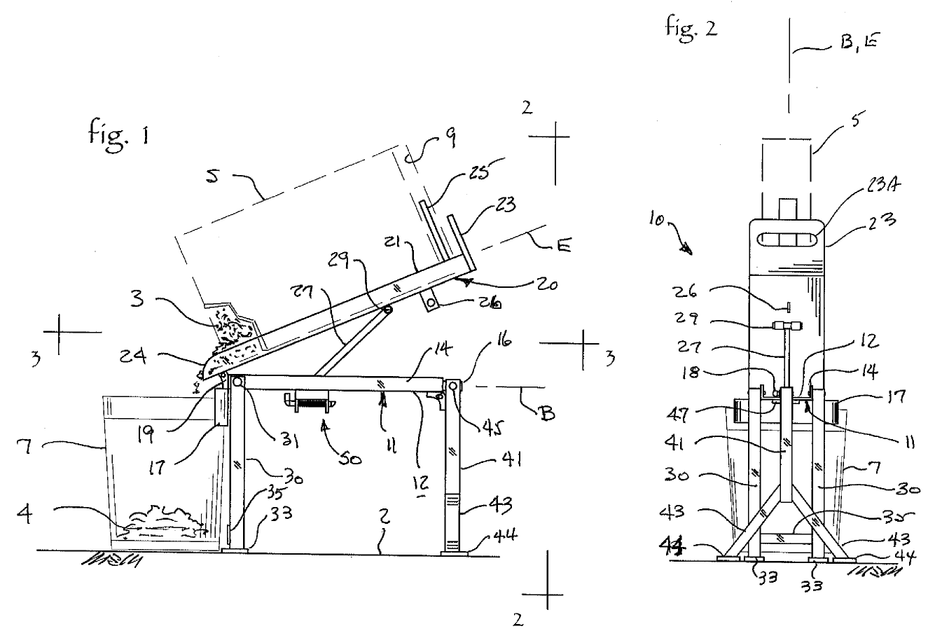

Coupled to base 11 by hinge 19 adjacent shoe 17, elevator 20 preferably comprises a second weldment of aluminum channel having bottom 21 sandwiched between elevator walls 22 and disposed along and bifurcated by elevator axis E. Walls 22 extend generally upward from and perpendicular to bottom 21 and form a channel for embracing and confining bag 5 to prevent it from slipping sideways off of elevator 20 during use. Walls 22 also serve to confine any small quantities of dry mortar 3 which inadvertently escape bag 5 and to channel dry mortar 3 toward container 7. Walls 22 terminate near shoe 17 and taper or curve toward bottom 21 to form and define mouth 24 through which dry mortar 3 is directed toward container 7. Opposite mouth 24 and disposed transverse axis E between the rear ends of walls 22, handle 23 extends perpendicular to bottom 21 to surround and define a horizontal slot, or finger hole 23A. Handle 23 allows a user conveniently to grasp elevator 20 while raising it into one or another of a plurality of tilted positions (one shown in FIGS. 1 and 2), having an angular displacement about hinge 19 and above base 11, to pour the desired amount of dry mortar 3 from bag 5.

Disposed beneath bottom 21, prop retention means for retaining elevator 20 in one or another of said tilted positions comprises prop rod 27 coupled by its end proximate bottom 21 to prop hinge 29 and extending downward toward base 11 to terminate at its distal end in nose 28A (see FIG. 3). Disposed horizontally and transverse rod 27 a spaced distance from the distal end of rod 27, crossbar 28 forms and defines nose 28A. Nose 28A is adapted to extend selectively into one of apertures 13 until its insertion thereinto is limited by crossbar 28. Crossbar 28 spans the width of apertures 13 and rests against back 12 of base 11, thereby supporting the weight of elevator 20 and dry mortar bag 5.

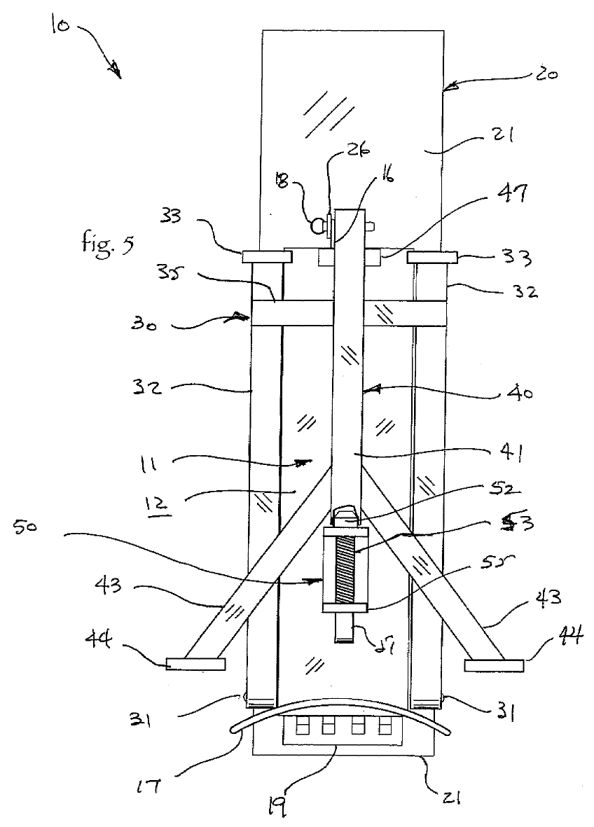

Also disposed beneath elevator 20 bottom 21, gussett 26 aligns with retaining lug 16 affixed to the rear of base 11 (see FIG. 3). When elevator 20 is untilted and disposed adjacent and parallel to base 11, pin 18 (FIG. 5) may be journaled through aligned apertures in both gusset 26 and lug 16 to hold elevator 20 in such folded position for transportation and storage. Pin 18 and lug 16 are discussed in more detail below with regard to rear leg assembly 40.

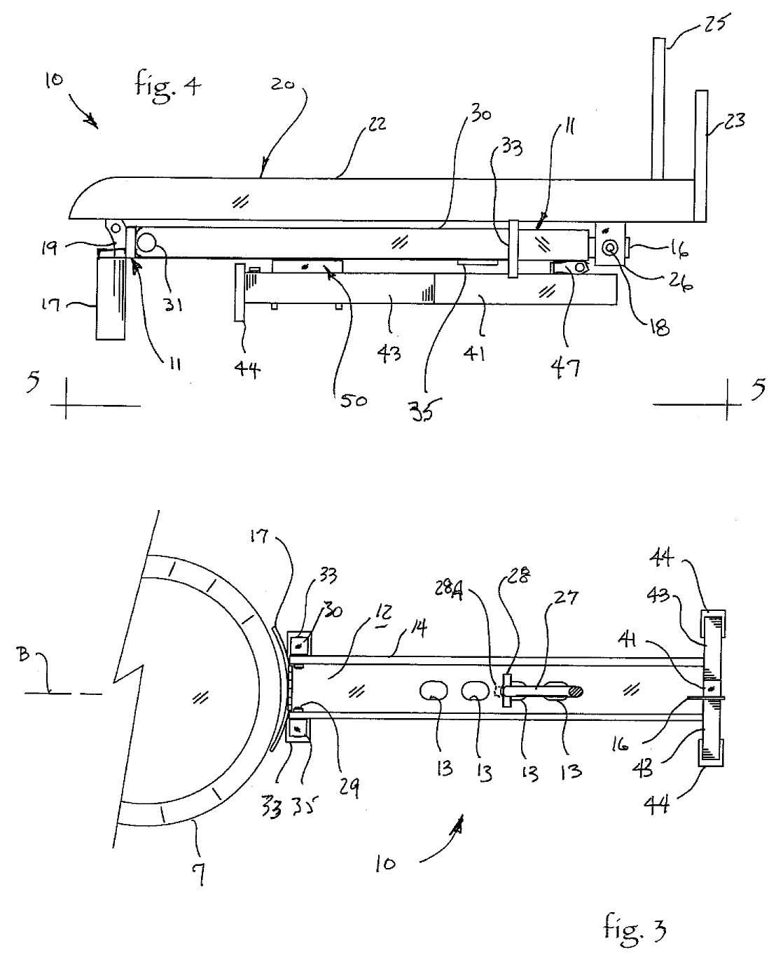

Turning now also to FIGS. 4 and 5, front leg assembly 30 couples to the front of base 11 rearward of shoe 17 by leg pins 31. Each leg 32 of front leg assembly 30 preferably comprises an elongate, preferably square, aluminum tube closed at its upper end to enclose leg pin 31 and at its lower end by footpad 33. Leg pins 31 each comprise a bolt, washer and nut assembly of known configuration for extending through legs 30 and sides 12 to pivotally affix legs 32 to base 11. Legs 32 each articulate between a fully extended position perpendicular to base 11, as depicted in FIGS. 1-3, and a folded position substantially parallel to and disposed on opposite sides of base 11, as depicted in FIGS. 4 and 5. Preferably, brace 35 extends between legs 32 to hold them together and parallel each other such that they articulate between their extended and folded positions as front leg assembly 30.

Rear leg assembly 40 comprises single rear leg post 41 coupled to the rear end of base 11 by rear leg hinge 47 such that in its extended position perpendicular to base 11, post 41 is disposed adjacent the rear end of base 11. Post 41 preferably comprises a length of square aluminum tubing closed at its proximate end adjacent base 11 but open at its distal end to define and surround an opening for receiving latch 50, as discussed in more detail below. Rear legs 43 disposed on the distal end of post 41 extend therefrom at an oblique angle to terminate in rear leg footpads 33.

When post 41 is in its extended, vertical position, as depicted in FIGS. 1-3, pin hole 45 in the proximate end of post 41 aligns with the aperture in lug 16. Pin 18 may be inserted through lug 16 and pin hole 45 to secure rear leg assembly 40 and prevent stand 10 from collapsing rhomboidly (parallel base axis B) while in use or under the load of bag 5. Because of this security measure, no pinning system is necessary for front leg assembly 30 though one having ordinary skill in the art would recognize that one could be provided. Further, rear legs 43 form a stable, triangular base with resting surface 2 in a plane transverse base axis B, thereby laterally stabilizing stand 10 to prevent it from tipping over sideways. Thus, rear leg assembly 40 provides both longitudinal and transverse stability for stand 10 when in use and under load from bag 5.

In its folded position, as depicted in FIGS. 4-5, rear leg assembly 40 engages latch 50 disposed on the underside of base 11. As best seen in FIG. 5, plunger 51 is biased toward the distal end of post 41 to cause plunger nose 52 to extend into the interior of post 41 through its open end. Post 41 lays across brace 35, and rear legs 43 extend across front legs 32 such that front leg assembly 30 cannot pivot out of its folded position. Thusly, latch 50 not only holds rear leg assembly 40 but also front leg assembly 30 in their respective folded positions. As mentioned above, pin 18 is journaled through lug 16 and gusset 26 to hold elevator 20 in its untilted storage position parallel to base 11. In such fashion, stand 10 is secured for transportation and storage.

The lengths of front and rear leg assemblies 30, 40 are selected to elevate base 11 to any desired height. As depicted in the figures, front and rear leg assemblies 30, 40 elevate base 11 just high enough that elevator 20 extends over the top of mixing container 7. Thereby mouth 24 can channel dry mortar 3 and discharge it into container 7 when elevator 20 is tilted as shown in FIGS. 1 and 2, or from any other tilted positions similar thereto, including, if appropriate, elevator 20's fully folded and horizontal position adjacent base 11. Though stand 10 has been depicted and discussed herein in use with container 7, one having ordinary skill in the art will recognize that leg assemblies 30, 40 could be selected for use with other mixing containers, resulting in different lengths for leg assemblies 30, 40, or could be omitted altogether in favor of a fixed base adjacent a stationary mortar mixing vat, or on a vehicle, without departing from the spirit and scope of the present invention.

In operation, a user prepares to conduct a mortaring job by first marshaling in the vicinity of stand 10 dry mortar bag 5, container 7, a water source (not shown) and means for stirring (not shown) admix 4. Next, the user unfolds rear leg assembly 40 by pulling forward (toward shoe 17) on plunger 51 to compress biasing spring 53 until nose 52 clears the distal end of post 41. This allows the user to pivot rear leg assembly 40 into its extended position. The user removes pin 18 from lug 16 and gusset 26, aligns pin hole 45 with lug 16 and re-inserts pin 18 through lug 16 and into pin hole 45 until it protrudes out the other side of post 41. A small aperture (not shown) in the end of pin 18 may be provided for a keeper (not shown) to be placed through pin 18 to prevent it from inadvertently backing out of engagement with post 41. The user then fully extends front leg assembly 30 and erects stand 10 upright with its footpads 33, 44 resting on surface 2 and shoe 17 nested against container 7.

Next, the user prepares bag 5 for use with stand 10 by first making sure there is sufficient space beneath the flaps on one end thereof to receive spine 25. This does not require, nor in fact is it desirable, that such end of bag 5 be opened to its interior, but merely that the user insure that narrow gap 9 (see FIG. 1) between the flaps and the main part of bag 5 is available for insertion therein of spine 25. The user then prepares the other end of bag 5 by opening a pouring port (not shown) through bag 5 into its interior near one corner of bag 5. The size of such port is selected as a partial means of regulating the flow of dry mortar 3 from bag 5, and may be very small or as large as the entire end of bag 5. This operation is substantially identical to preparation of bag 5 for pouring without using stand 10 except for the concern for gap 9 provided for spine 25, as discussed above. Once bag 5 is prepared for pouring, the user lifts it and places it onto elevator 20 with one of its narrow sides resting between walls 22, thereby positioning the pouring port adjacent mouth 24 and back 21. In so placing bag 5, the user inserts spine 25 into gap 9. Spine 25 thereafter serves both to hold bag 5 in the resulting substantially upright position resting on one of its narrow sides atop elevator 20, as well as to prevent it from sliding toward mouth 24 when elevator 20 is tilted to regulate pouring of dry mortar 3 into container 7.

In all likelihood, at this juncture, some dry mortar 3 will have spilled out of the pouring port in bag 5 and onto elevator 20 between walls 22. This presents little or no problem for the user, because walls 22 confine dry mortar 3 and direct it toward mouth 24 where it is discharged into container 7. To varying degrees determined by the extent to which the flaps of bag 5 near the front of stand 10 are opened, dry mortar 3 cascades from bag 5 onto bottom 21 and out mouth 24 into container 7 without the user tilting elevator 20 at all. As such dry mortar 3 flow slows, the user then can raise elevator 20 as needed to increase and regulate such dry mortar 3 flow into container 7. The user then manipulates the water source and stirring means to create admix 4 within container 7, regulating the water and/or the flow of dry mortar 3 to create the proper viscosity for admix 4. At the beginning of the mixing operation, the water already have been introduced into container 7 in most cases. As the user desires, he may promote more of dry mortar 3 to cascade from bag 5 and into container 7 to increase the volume of admix 4, at first by simply squeezing or bumping bag 5, and then by grasping handle 23A to lift elevator 20 into one of a series of successively greater tilted position of increasing angular displacement above base 11, all the while stirring and adding water to admix 4.

By selectively positioning nose 28A into each aperture 13, the user can determine with accuracy the degree of tilt of elevator 20. As nose 28A is moved from aperture 13 nearest hinge 24 to apertures successively further from hinge 24, elevator 20 is tilted at successively greater angular displacements relative to base 11. The user grasps handle 23 and lifts until prop nose 28A clears one aperture 13 and slides along axis B until it drops into the next aperture 13. At this point, if sufficient tilt is achieved, the user relaxes his lift on handle 23 and lets crossbar 28 rest against back 12, thereby affixing elevator 20 in the new tilted position. As more dry mortar 3 is needed (e.g. when bag 5 begins to empty, or for a faster pour), the user again grasps handle 23 and increases the tilt of elevator 20. To impede or stop flow of dry mortar 3 from bag 5, the user lifts handle 23 slightly to disengage prop nose 28A from aperture 13 and lowers elevator 20 to a lower angular displacement, or all the way to its storage position parallel and adjacent base 11 while manually supporting rod 27 with his other hand. In elevator 20's fully folded, horizontal position adjacent base 11, rod 27 rests atop back 12 between sides 14 of base 11. Once the right amount of admix is prepared, the user ceases the pouring process, closes the pouring port in bag 5 temporarily until he desires to mix another batch of admix 4, and proceeds with his mortaring project

The present invention, described in either its preferred or alternate embodiment, thus serves to handle the weight of bag 5 during the pouring procedure to create admix 4. By relieving the user of this weight, which at first typically is as much as eighty pounds (for dry mortar), stand 10 permits the user to direct his attention to the quantity and quality of admix 4 without concern for injury, spillage or having to make too much admix for the project because of imprecise pouring of dry mortar 3. The invention also helps in preventing a user from having to inhale dry mortar 3 dust and to adjust the consistency and smoothness of admix 4.

While the invention has been particularly shown and described with reference to one or more embodiments, it will be understood by those skilled in the art that various changes in form and detail may be made therein without departing from the spirit and scope of the invention. For example, base 11 was described above as a length of aluminum channel formed by back 12 with sides 14 extending generally upward. Other configurations for base 11 could serve as well, such as an H-shaped length of aluminum bar, a solid block of aluminum, or by reversing the channel formed by back 12 and sides 14 such that the latter extend downward toward surface 2. In the latter two circumstances, means for providing a recess between back 11 and bottom 21 of elevator 20 must be provided if the elevator prop means described using prop rod 27 and apertures 13 is employed. However, alternate prop means could be employed, such as dual props pivotally coupled to each side of elevator 20 and adapted to engage notches in base 11 without requiring any recess between base 11 and elevator 20.

Further, elevator 20 has been described as adapted to be manually manipulated using handle 23A, with prop 27 serving to hold it into one of its plurality of tilted positions angularly displaced above base 11. Alternately, base 11 could be equipped with a worm gear (not shown) and elevator 20 with a traveler gear (not shown) to equip stand 10 with a crank-or motor-driven rack-and-pinion method for raising and lowering elevator 20. In such case, friction along in the rack-and-pinion mechanism may be sufficient to hold elevator 20 in its various tilted positions, or a small catch or chuck may be employed for safety. These alternate elevator 20 movement means may well become increasingly important as stand 10 is adapted for larger bags 5 and affixed to a large vat (not shown) or vehicle for mixing larger volumes of admix 4, as discussed above.

Finally, stand 10 has been described as fabricated entirely from aluminum stock, be it aluminum tubes for legs 32, 43 and post 41, and channel for elevator 20 and base 11. Stand 10 could, however, be fabricated from other materials, such as steel, wood or high grade extruded thermoset plastics, with concomitant variations in thicknesses and sizes of various elements to provide the required strength of materials.

I claim:

1. A mortar mixing stand adapted to hold and manipulate a dry mortar bag, the bag having a substantially rectangular shape with proportionately narrow sides and ends having closure flaps and containing a quantum of dry mortar adapted to be mixed with water for use, the stand comprising
a base having
a front and a rear separated by a longitudinal base axis;
a front leg assembly coupled to the front; and
a rear leg assembly coupled to the rear;
a bag elevator hingedly coupled to the base adjacent the front and adapted to articulate between a plurality of raised positions angularly displaced above the base and a lowered position substantially adjacent to and parallel the base, the elevator having
a longitudinal elevator axis coplanar with the base axis;
a platform extending along the base axis between a hinge end and a handle end;
an end wall transverse the elevator axis at the handle end and extending from the platform to form a handle; and
bag holding means disposed on the platform for holding a bag of dry mortar on the elevator.

2. The mortar mixing stand according to claim 1 wherein the front leg assembly comprises
two front legs hingedly coupled to the base and adapted to articulate between an extended position perpendicular to the base and a folded position on opposite sides of the base wherein the front legs are flush with the base; and
a transverse brace coupled between the two front legs and adapted to hold them substantially parallel to each other.

3. The mortar mixing stand according to claim 2 wherein the rear leg assembly comprises
a rear leg post having a proximate end hingedly coupled to the base and a distal end surrounding and defining a post aperture; and
two rear legs coupled to the post at its distal end and extending diagonally therefrom and symmetrically transverse the base axis.

4. The mortar mixing stand according to claim 1 and further comprising
interface means coupled to the front of the base for interfacing between the stand and a mixing container in which the mortar is mixed with water.

5. The mortar mixing stand according to claim 1 wherein
the front leg assembly comprises
two front legs hingedly coupled to the base and adapted to articulate between an extended front leg position substantially perpendicular to the base and a folded front leg position substantially parallel to and on opposite sides of the base; and
the rear leg assembly comprises
a rear leg post having a proximate end hingedly coupled to the base and a distal end surrounding and defining a post aperture, the post adapted to articulate between an extended rear leg position substantially perpendicular to the base and a folded rear leg position substantially parallel the base; and
two rear legs coupled to the post at its distal end and extending diagonally therefrom and symmetrically transverse the base axis.

6. The mortar mixing stand according to claim 5 wherein
the front legs are flush with the base when in the front leg assembly is in the folded front leg position; and
the rear leg assembly is disposed across the front leg assembly when in the folded rear leg position and retains the front leg assembly in the folded front leg position.

7. The mortar mixing stand according to claim 5 and further comprising
latch means for latching the rear leg assembly in the folded rear leg position.

8. The mortar mixing stand according to claim 7 wherein the latch means comprises
a latch base disposed on the bottom of the base;
a plunger coupled to the latch base; and
a biasing spring coupled to the plunger and adapted to bias the plunger into a closed position wherein a portion of the plunger extends into the aperture in the rear leg post.

9. The mortar mixing stand according to claim 1 wherein the bag holding means comprises
a vertical spine extending perpendicular to the platform adjacent the handle and adapted to be journaled beneath one of the closure flaps of the mortar mix bag.

10. The mortar mixing stand according to claim 1 and further comprising
elevator position retaining means for retaining the elevator in one of a plurality of positions angularly displaced above the base.

11. The mortar mixing stand according to claim 10 wherein the elevator position retaining means comprises
a plurality of prop apertures surrounded and defined by the platform and disposed along the base axis; and
prop rod means coupled to the elevator and adapted selectively to be received within the prop apertures one at a time and to cooperate with the platform to support the weight of the elevator.

12. The mortar mixing stand according to claim 10 wherein the prop rod means comprises
a single prop rod having
a proximate end hingedly coupled to the elevator and a distal end;
a nose disposed on the distal end and adapted selectively to be received within each of a plurality of apertures surrounded and defined by the base and arrayed along the base axis;
a crossbar disposed transverse the prop rod a spaced distance from the nose, the crossbar adapted to engage the base on either side of the apertures to limit the extend to which the nose extends into the apertures.

13. A stand for use in mixing dry mortar with water, the dry mortar contained in a dry mortar container having sides and ends, an interior, and closure means disposed on the ends, the stand comprising
a base having
a front and a rear;
front leg means coupled to the base near the front for elevating the front above a resting surface;
rear leg means coupled to the base near the rear for elevating the rear above the resting surface;
an elongate platform hingedly coupled to the base near the front and adapted to articulate between a storage position substantially parallel the base and a plurality of pouring positions angularly displaced above the base, the platform having
a handle for manipulating the platform between pouring positions;
retention means for retaining the platform in each of the pouring positions; and
mortar container holding means for holding the mortar container on the elevator.

14. The stand according to claim 13 and further comprising
interface means coupled to the front of the base for interfacing between the stand and a mixing container in which the dry mortar is mixed with water.

15. The stand according to claim 13 wherein
the front leg means comprises two front legs hingedly coupled to the front and adapted to articulate between an extended front leg position substantially perpendicular to the base and a folded position substantially parallel to and on opposite sides of the base; and
the rear leg means comprises
a rear leg post adapted to articulate between an extended rear leg position substantially perpendicular to the base and a folded rear leg position substantially parallel the base, the post having
a proximate post end hingedly coupled to the base;
a distal post end opposite the proximate post end and surrounding and defining a post aperture coaxial with the post;
two rear legs, each disposed on the distal end of the post and extending at an angle thereto in a plane transverse the base axis;
a latch disposed on the base and having a spring-loaded plunger adapted to cooperate be received within the post aperture for holding the rear legs in the folded rear leg position.

16. The mortar mixing stand according to claim 15 and further comprising
a brace transversly coupled to the front legs and adapted to retain them parallel to each other.

17. An improved method of mixing mortar, the mortar adapted to be mixed from water and a dry mortar contained within a dry mortar bag having substantially parallel sides extending between opposite ends, the ends having closure flaps, the method comprising
providing a stand adapted to hold the dry mortar bag and having
a base elevated above a resting surface by a pair of front legs and a pair of rear legs, the base having a base axis extending between a front and a rear;
an elevator hingedly coupled to the base at its front and adapted to articulate between a storage position substantially parallel the base and a plurality of pouring positions angularly displaced above the base, the elevator having
a handle for manipulating the elevator between the storage and pouring positions;
retention means for retaining the elevator in each of the pouring positions; and
mortar bag holding means for holding the dry mortar bag on the elevator; and
providing a mortar mixing container and stirring means for stirring water with the dry mortar in the mixing container; then
positioning the stand with its front adjacent the mixing container;
placing the mortar bag onto the elevator with one of its ends disposed adjacent the front;
engaging the mortar bag holding means; then
opening the mortar bag at its end adjacent the front; then
(1) selectively elevating the mortar bag using the elevator to one of the pouring positions;
(2) encouraging a measured amount of the dry mortar into the mixing container; and
(3) adding a measured amount of water into the mixing container; then
(4) stirring the water and the dry mortar together with the stirring means; then
repeating steps (1) through (4) inclusive until a desired amount of mortar is mixed in the mixing container; then
lowering the elevator to one of the plurality of pouring or storage positions to halt the dry mortar from pouring from the mortar bag.

18. The improved method of claim 17 wherein
the front and rear legs hingedly couple to the base and are adapted to articulate between a folded position against the base and an extended position substantially perpendicular to the base; and
the method includes the additional steps of
prior to the positioning step, unfolding the legs from the folded position to the extended position; and
after the lowering step,
returning the elevator to the starting position and latching it in place; then
folding the front legs against the base; then
folding the rear legs against the base and across the front legs; then
latching the rear legs in their folded position.

19. The improved method of claim 17 wherein the retention means comprises
a prop rod having
a hinge end coupled to the elevator by a hinge;
a nose end opposite the hinge, the nose end adapted to be received within a plurality of prop apertures surrounded and defined by the base and disposed along the base axis; and
a crossbar disposed transverse the prop a spaced distance from the nose end, the crossbar adapted to engage the base on either side of the prop apertures to support the weight of the elevator and the mortar bag.
